(19) United States
(12) Patent Application Publication
(10) Pub. No.: US 2020/0174821 A1
(43) Pub. Date: Jun. 4, 2020

(54) SYSTEM, METHOD AND COMPUTER PROGRAM FOR VIRTUAL MACHINE RESOURCE ALLOCATION

(71) Applicant: Huawei Technologies Co., Ltd., Shenzhen (CN)

(72) Inventors: Antonios ILIOPOULOS, Munich (DE); Vladi VEXLER, Hod Hasharon (IL)

(21) Appl. No.: 16/779,083

(22) Filed: Jan. 31, 2020

Related U.S. Application Data
(63) Continuation of application No. PCT/EP2017/069579, filed on Aug. 2, 2017.

(51) Int. Cl. G06F 9/455; G06F 9/54; G06F 9/50

(52) U.S. Cl. CPC G06F 9/45558; G06F 9/546; G06F 9/5077; G06F 9/5027; G06F 2009/45583; G06F 2209/508; G06F 2009/45595; G06F 2209/503; G06F 9/5016

(57) ABSTRACT

A system includes a processor and a memory, resources selected from processing resources and memory resources, and a computer program stored in the memory. The computer program includes two or more virtual machines and a hypervisor having access to the resources. When the computer program is executed in the processor, any one of the two or more virtual machines is configured to request additional resources by sending a resource request to the hypervisor. The hypervisor receives the resource request from the requesting virtual machine and checks for available unallocated resources. In response to unallocated resources being available, the hypervisor allocates at least part of these resources to the requesting virtual machine.

### CROSS-REFERENCE TO RELATED APPLICATIONS

This application is a continuation of International Application No. PCT/EP2017/069579, filed on Aug. 2, 2017, the disclosure of which is hereby incorporated by reference in its entirety.

### TECHNICAL FIELD

The present application relates to the field of computer system emulation, and more particularly to virtualization and virtual machines.

### BACKGROUND

With the advancements of server hardware increasing capacity of computing resources, the computing is shifted towards virtual and cloud computing platforms. Clients of such platforms receive or rent computing resources from a platform provider as pre-configured and isolated Virtual Machines or Containers (“VMs”), by partitioning a physical machine by means of a Hypervisor into multiple VMs.

While normally the configuration of resources of VMs is static, the workloads are dynamic and subject to change in short periods of time, both in planned and unplanned manner. As such the specific physical resource requirements (e.g. central processing unit cores, memory) of VMs typically vary during the runtime.

The ability to change the configuration of VMs at runtime without having to stop, restart or reboot can be a challenge. Co-located VMs in a physical machine may be isolated and without means of signaling intention of acquiring or releasing resources amongst them.

### SUMMARY

The present disclosure provides improved communication and resource distribution between virtual machines of a system, including, for example, an improved system and method for resource allocation between virtual machines and a hypervisor.

According to a first aspect of the present disclosure, a system is provided. The system may be a resource management system, a system for distributing resources among virtual machines, or any other system that includes resource distribution functionality. The system includes: a processor, a memory and resources including at least one of: processing resources and memory resources. The resources may be provided in the processor and in the memory of the system, or as separate dedicated processors and memory modules. The system also includes a computer program stored in the memory, the computer program including: two or more virtual machines and a hypervisor having access to the resources. The virtual machines may be originally created by the hypervisor or a separate software. The hypervisor has access to resources and may be configured to control their distribution.

When the computer program is executed in the processor, at least part of the resources is allocated among the two or more virtual machines. This initial allocation of resources needed for normal operation may be pre-determined or decided by the hypervisor.

Any one of the two or more virtual machines is configured to request additional resources by sending a resource request to the hypervisor, and the hypervisor is configured to receive the resource request from the requesting virtual machine and check for available unallocated resources. If unallocated resources are available, the hypervisor is configured to allocate at least part of the unallocated resources to the requesting virtual machine. If unallocated resources are unavailable, the hypervisor is configured to check for allocated resources that can be released by any of the one or more virtual machines that are not the requesting virtual machine, and reallocate these resources to the requesting virtual machine.

When requesting additional resources, the requesting virtual machine can be seen as a guest, and the hypervisor as a host. The hypervisor has access to resources and first checks if unallocated resources are available. The unallocated resources may be stored specifically for distribution among the already working virtual machines, or may be stored both for reallocation and allocation to new virtual machines. If no such resources are available, the hypervisor is configured to “ask” other virtual machines if they can release resources, and reallocate the available released resources to the guest virtual machine.

The system according to the first aspect improves efficiency of resource distribution between virtual machines. It also allows for secure and anonymous communication between a plurality of VMs on single physical machine or among several physical machines, with the hypervisor acting as a message bus.

In a first possible implementation of the system according to the first aspect, when the computer program is executed in the processor, the hypervisor is configured to check for allocated resources that can be released by any of the virtual machines that are not the requesting virtual machine by sending a request for releasing resources to the virtual machines. The virtual machines are then configured to receive the request for releasing resources, check for unused resources allocated to them, and send replies with information about unused resources to the hypervisor. The hypervisor is configured to dynamically release the unused resources based on the replies received from the virtual machines, and reallocate the dynamically released resources to the requesting virtual machine.

In this implementation, the hypervisor negotiates with the virtual machines by sending and receiving messages. The negotiation includes checking if there are resources already allocated that are not useful to one or more virtual machines, and using this information to reallocate the resources. Dynamic release of the allocated resources provides the possibility to reallocate resources without pausing the operation of the virtual machines or the hypervisor.

In a second possible implementation of the system according to the first implementation of the first aspect, the hypervisor is configured to reallocate the dynamically released resources to the requesting virtual machine by sending a resource allocation message to the requesting virtual machine. The requesting virtual machine is configured to receive the resource allocation message from the hypervisor and hot-plug the dynamically released resources in accordance with the resource allocation message. The dynamically released resource is “hot-plugged” meaning the resource is added “on the fly” without requiring a reboot/restart of a virtual machine. This provides for effective online allocation of memory or CPU resources. The resource reallocation is thus realized in three stages: an allocation/reservation message is sent by the host/hypervisor, then an assignment/association of the allocated resources is made to a virtual machine (also by the hypervisor), and subsequently, a signaling of the virtual machine that actually discovers and activates (i.e. “hot-plugs”) the additional resources.

The resource allocation message can be a message including information about the available additional resources for hot-plugging and instructions to the virtual machine to use those resources. Hot-plugging also provides the possibility to carry out the allocation with-out pausing any component of the computer program.

In a third possible implementation of the system according to the first aspect as such or according to any of the preceding implementations of the first aspect, the processing resources include at least one of: central processing unit cores and virtual central processing unit cores. The virtual central processing unit cores can be processes or threads of execution decoupled from physical central processing unit cores, leaving the machine resources oversubscribed and time-multiplexed. They can also be mapped 1:1 to physical cores.

The central processing unit cores may be part of the processor of the system, or they might be part of a separate processing unit used as a resource.

In a fourth possible implementation of the system according to the first aspect as such or according to any of the preceding implementations of the first aspect, the memory resources include random access memory (RAM).

In a fifth possible implementation of the system according to the first aspect as such or according to any of the preceding implementations of the first aspect, the memory resources include non-volatile memory.

The RAM and the non-volatile memory may be part of the memory of the system, or it may be stored as separate memory modules used as resources.

In addition to the resources according to the third to fifth implementations, the resources can additionally include input and output resources, network bandwidth resources, and other resources that may be required for optimal operation of virtual machines.

In a sixth possible implementation of the system according to the second implementation of the first aspect, the hypervisor is configured to assign a value to the dynamically released resources, and reallocate the dynamically released resources based on their value.

This further specifies negotiation between the hypervisor and the virtual machines. Adding value to the resources provides efficient distribution of resources between virtual machines. It also provides the ability to create a marketplace where the virtual machines are able to trade resources based on their value.

In a seventh possible implementation of the system according to the first aspect as such or according to any of the preceding implementations of the first aspect, the hypervisor includes a resource management component and a communication component configured to send messages to, and receive messages from, the resource management component and the two or more virtual machines.

The communication component of the hypervisor can be configured to generate and pass messages between the virtual machines and the resource management component. The resource management component can be configured to manage unallocated resources, make a decision that additional resources are required from the virtual machines that are not the requesting virtual machine (if unallocated resources are unavailable), and instruct the communication component to request the virtual machines that are not the requesting machines to release unused allocated resources. The resource management component may be configured to generate request messages and resource allocation requests, and instruct the communication component to pass these messages; or it may be configured to instruct the communication component to generate resource allocation requests and other messages to the virtual machines.

In an eighth possible implementation of the system according to the second implementation of the first aspect, each of the two or more virtual machines includes a communication component and a dynamic resource communicator library. The dynamic resource communicator library is configured to: receive resource requests from applications running internally on the virtual machine, pass the resource requests to the hypervisor via the communication component, receive requests for releasing resources from the hypervisor via the communication component, process the requests for releasing resources, and send replies with information about unused resources to the hypervisor via the communication component.

The dynamic resource communicator library of the virtual machine can process requests for releasing requests and determine whether allocated resources can be released. In some implementations, value of the allocated resources and requested resources can also be taken into account in the determination.

The resource request of a virtual machine can be initiated by an application running on the virtual machine, for example if said application requires more resources to run optimally.

According to a second aspect of the present disclosure, a method is provided. The method may be a method for resource allocation in a system including two or more virtual machines and a hypervisor. The system may be a system according to the first aspect or any of its implementations. The method includes: initiating a resource request communication between any one of the two or more virtual machines and the hypervisor, and checking for unallocated resources available to the hypervisor. If unallocated resources are available, at least part of the unallocated resources are allocated to the requesting virtual machine. If unallocated resources are unavailable, the method includes checking for allocated resources that can be released by any of the one or more virtual machines that are not the requesting virtual machine, and reallocating these resources to the requesting virtual machine.

The resource request communication can include messages sent from a virtual machine to the supervisor, and the other way around.

The method enables dynamically adding and releasing resources using a cooperate communication. This allows an application running on a virtual machine to obtain additional resources or release unused allocated resources. The method may be performed by a processor of the system it is run on.

In a first possible implementation of the method according to the second aspect, the method further includes: initiating a second communication for releasing resources between the hypervisor and the virtual machines that are not the requesting virtual machine; checking for unused resources allocated to the virtual machines that are not the requesting virtual machine; providing information about unused resources to the hypervisor; and dynamically releasing the unused resources based on the provided information, and reallocating the dynamically released resources to the requesting virtual machine.

The second communication for releasing resources can include messages sent from the hypervisor to the virtual machines instructing to check for unused allocated resources, and/or instructions to dynamically release resources.

In a second possible implementation of the method according to the first implementation of the second aspect, the method includes reallocating the dynamically released resources to the requesting virtual machine by passing resource allocation instructions from the hypervisor to the requesting virtual machine, and hot-plugging the dynamically released resources in accordance with the resource allocation instructions.

The passing of resource allocation instructions may also be performed by initiating a dedicated communication channel between the hypervisor and the requesting virtual machine.

In a third possible implementation of the method according to the second aspect as such or according to any of the preceding implementations of the second aspect, the method further includes: initiating a resource request from an application running internally on any one of the two or more virtual machines prior to initiating a resource request communication between the requesting virtual machine and the hypervisor.

This allows applications running on the virtual machines to initiate the resource request chain according to the method.

According to a third aspect of the present disclosure, a computer program is presented. The computer program includes program code configured to perform a method according to any one of the implementations of the second aspect, when the computer program is executed on a computer.

Many of the attendant features will be more readily appreciated as they become better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram illustrating a system according to an example embodiment;

FIG. 2 is a block diagram illustrating a system with further elements according to an example embodiment;

FIG. 3 is a block diagram illustrating handling of resources in virtual machines according to an example embodiment; and

FIG. 4 is a flow chart illustrating a method according to an example embodiment.

Like references are used to designate like parts in the accompanying drawings.

### DETAILED DESCRIPTION

The detailed description provided below in connection with the appended drawings is intended as a description of exemplary embodiments and is not intended to represent the only forms in which the embodiment may be constructed or utilized. However, the same or equivalent functions and structures may be accomplished by different embodiments.

In the following description, embodiments of a system and method for cooperative, secure and anonymous communication between a number of Virtual Machines (VMs) on a physical machine are discussed.

The system is based on establishment of a controlled communication channel between a plurality of VMs and their hypervisor (HV), over which resource adjustment messages can be sent.

To clarify certain principles underlying the present disclosure, an exemplary explanation is provided herein before the description makes reference to the accompanying drawings. This is not intended to be a limiting explanation in any way, and rather provides specific details for clear understanding of the mechanisms underlying the claimed system and method.

Operating system kernels running within the guest (VM) and the host (HV) can be extended with a driver that enables a protocol-based communication channel between the guest and the host machine. Applications running within a “guest” VM can be configured to send or receive resource change messages. The driver running on a VM can react upon receiving messages from the applications, and accordingly carry the messages to the host, in a secure manner (for example, by leveraging hardware-assisted virtualization techniques such as virtio-based channels). The driver running within the HV host can react upon the reception of the messages from the VM driver, and pass the messages to a management software component running as an application in the host. The management software component in turn can control the acquisition and release of managed resources, and can implement a range of policies. The management component may fulfill a resource request by leveraging existing available resources, or alternatively push a request message to one or multiple VMs that are concurrently running under the same hypervisor. The request message can poll if any of the running VMs may intent to release the requested resources that could be subsequently acquired by the initially requesting VM. The communication mechanism used for pushing messages to the VMs may be the same as the one used by VMs to send messages to the HV. The messages are delivered to the driver within the guest VMs, and subsequently processed by a user-space application running in the guest t can handle the request and approve or decline a request for releasing resources. The management component, depending on the decision, for example if one of the VMs accepted to release said resources, proceeds with dynamically freeing the resources with the cooperation of the accepting VM without any service disruptions (by hot-unplugging processing and memory resources), and subsequently allocating those resources to the initially requesting VM. Finally, a message can be returned to the originally requesting VM, which confirms or rejects the initial request. If the request is approved, then the message can further include implementation-specific details on the acquired resources, so that the guest VM operating system kernel can proceed with dynamically hot-plugging those resources.

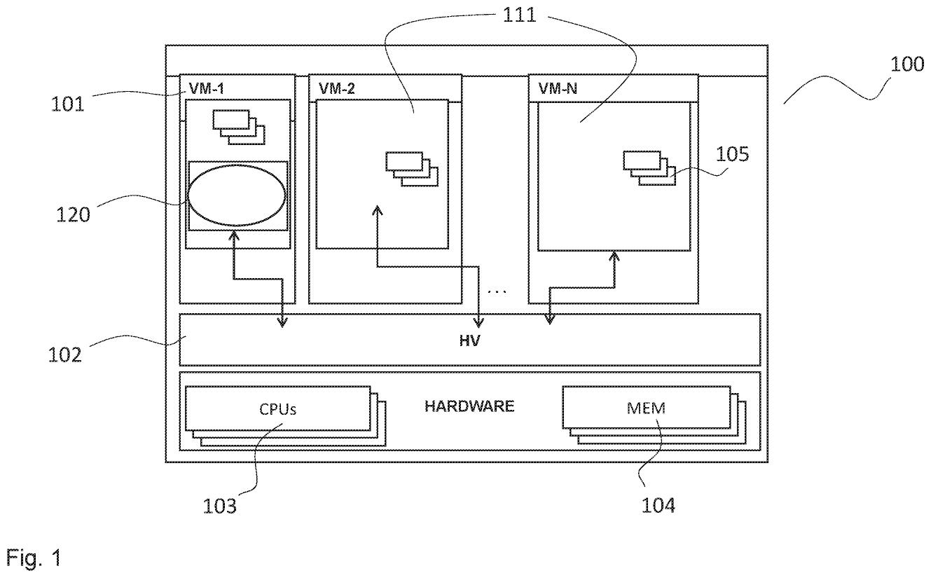

FIG. 1 shows a system 100 on a general level, the system including a memory 104 and a processor 103, denoted by the word “HARDWARE” on the Figure. The memory 104 stores a computer program, elements of which are illustrated as elements of the same system for clarity only. As it is clear to a skilled person, the hypervisor (HV) 102 and the virtual machines (VMs) 101, 111 are software-based components. The system also includes resources including processing resources, memory resources, and optionally other resources for optimal functioning of VMs. Part of the resources is allocated between the VMs running under the HV, these resources are denoted with 105 on FIG. 1. Another part of the resources is unallocated and, for simplicity purposes, is shown as “stacks” under the processor 103 and memory 104. The unallocated resources may be the resources of the system's memory 104 and processor 103, as shown in FIG. 1, or they may be separate from the memory 104 and processor 103. Memory resources may include Random Access Memory (RAM) and/or non-volatile memory. Processing resources may include central processing unit (CPU) cores, and virtual CPU cores.

When the computer program is executed in the processor 103, at least part 105 of the resources is already allocated among the two or more virtual machines 101, 111. Any one of the virtual machines, for example VM-1 at 101, can be configured to request additional resources by sending a resource request 120 to the hypervisor 102. The hypervisor 102 is configured to receive the resource request from the requesting virtual machine and check for available unallocated resources, such as CPUs 103 and available memory 104. If unallocated resources are available, the HV 102 is configured to allocate at least part of the unallocated resources to the requesting virtual machine 101. If unallocated resources are unavailable, the HV 102 is configured to check for allocated resources 105 that can be released by any of the one or more virtual machines 111 that are not the requesting virtual machine, and reallocate these resources to the requesting virtual machine 101. Communications between the HV 103 and the VMs 101, 111 are indicated by arrow signs.

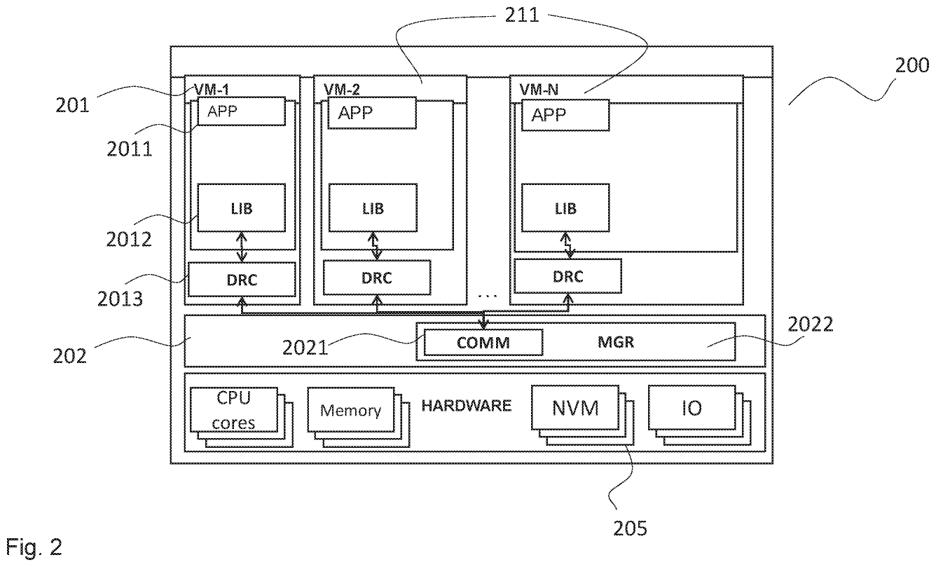

FIG. 2 shows a system 200 in further detail according to an embodiment. Certain elements responsible for the operations indicated in the description of FIG. 1, but are not intended to be interpreted as limiting the scope in any way. The system illustrated on FIG. 2 also includes additional resources 205, such as input-output resources, on top of the Memory and CPU cores already available.

For exemplary purposes only, VM-1 (201) is the virtual machine requesting additional resources. The VM-1 201, similar to other VMs 211, includes an application 2011 running on it, a communication component 2013 and a dynamic resource communicator library (DRC-LIB or LIB) 2012.

The application 2011 is configured to send a message of resource change request to DRC-LIB. The message may include resources definition, and optionally a resources value. DRC-LIB 2012 is configured to process the message and pass it to the communication component 2013, which in turn forwards this message to the hypervisor 202.

The hypervisor 202 includes a resource management component 2022 and a communication component 2021. As DRC-LIB 2012 forwards the message to the hypervisor 202, the message is received by the communication component 2021, and then passed on to the resource management component 2022. The resource management component 2022 checks if unallocated resources are available and creates the allocation message. If no unallocated resources are available, the resource management component creates a new message, with a new request id and content and sends it to one or plurality of communication components of the remaining VRs. The DRC-LIBs of the remaining VM-s that received the new message are configured to determine if the resource request shall be accepted or denied. A new message can be created and sent to communication component of the hypervisor, with the following text as an example: Accept/Deny request_id, [optional] Request to Add/Release resources, [optional] suggested value. The resources that are freed can then be hot-plugged to the requesting VM-1 201, after negotiating with the VM communication component 2013. The hypervisor 202 may also be configured to choose the specific VMs for resource changes; generate messages to add/release resources; and reorganize the resources in the resource management component 2022.

In case the resources are unavailable or insufficient in a VM during negotiation, the resource management component 2022 can create a message passing information about a request to provide or to accept resources, with a relative value to them. Such messages can be broadcasted to and accepted by all or some of the other virtual machines present on the physical machine. Based on their needs and availability the virtual machines can create their response.

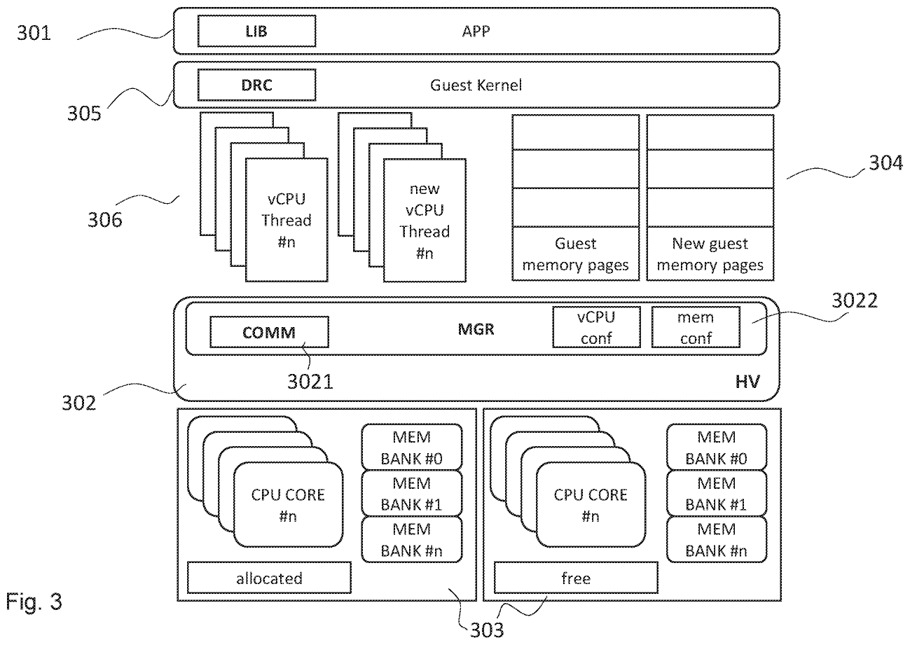

FIG. 3 illustrates more detailed examples of resource exchange mechanisms between the VMs and the HV. Components of the system involved in the resource exchange are illustrated in FIG. 3. These components include an application 301 running on a guest VM configured to request resource change via the DRC-LIB calls to the guest kernel 305. The communication component associated with the guest kernel 305 is configured to cause the requesting VM to exit the distribution, while the resource management component 3022 of the hypervisor 302 adjusts resources accordingly and sets up changes. The management component 3022 is configured to create new virtual central processing unit threads for, and allocate memory to the requesting VM.

In an embodiment, the resource management component 3022 then returns control back to the guest kernel 305 passing a status message to its DRC. The guest kernel 305 reads the status message and reacts, for example by hot-plugging new CPUs and/or adding new memory banks. Control is subsequently returned to the application 301 which may receive a message regarding newly available resources. This embodiment relates to synchronous dynamic adding of virtual resources to a requesting virtual machine.

In an alternative embodiment, asynchronous addition of virtual resources is provided. The resource management component, instead of returning control back to the guest kernel 305, may be configured to interrupt the operation of the guest kernel to pass the status message.

In an embodiment, the virtual machine of FIG. 3 may also be configured to release resources using cooperative communication. The mechanism of releasing resources begins with the guest kernel 305 receiving a message with instructions to release allocated resources from the hypervisor 302, or from an application 301, or from a user. The DRC in the guest kernel 305 can be configured to request the application 301 to release resources via the DRC-LIB of the VM. The application 301 can accept the request from the DRC-LIB and determine whether the resources can be released. After the application 301 determines whether resources can be released, it is configured to return a message informing of the result. If the result is negative, no resources are released. If the result is positive, DRC of the guest kernel performs a “hot unplug” of the requested resources. The DRC then passes the message to a communication module 3021 of the resource manager 3022 of the hypervisor 302. In response, the resource manager 3022 is configured to: adjust VM resources by communicating with the hypervisor 302 to setup changes, release virtual central processing unit threads and guest memory, and then return control back to the guest kernel, passing status info. DRC of the VM is configured to reads status info and refresh status of available CPUs and Memory.

The systems according to the embodiments above enable large degrees of flexibility in the implementation policies, such as market-based trading of resources. For example, the mechanism allows for multi-round protocols which may include series of bidding and selling of resources, at dynamically-managed prices.

The system further allows usage of a cooperative, secure and anonymous method utilizing the Hypervisor as the message bus, for communication between numerous VMs on single physical machine for the purposes of enabling: runtime fine-grained elasticity of resources; resource exchange and resource distribution and re-distribution; and market-based resource acquisition and exchange.

The system also provides the effect of increased resource distribution and usage efficiency.

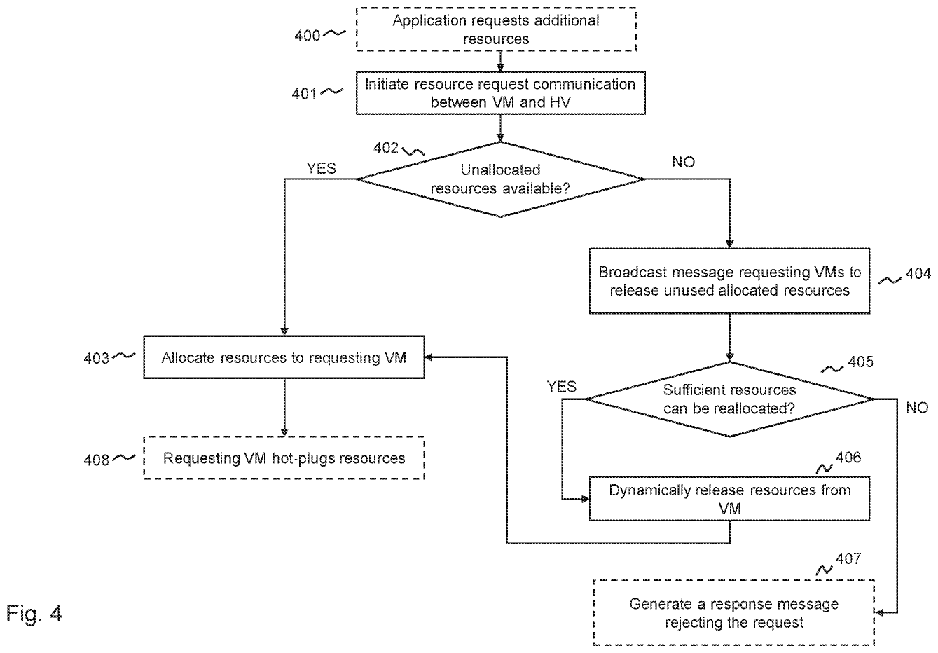

FIG. 4 illustrates a method for resource allocation in a system including two or more virtual machines and a hypervisor according to an embodiment. Optional steps of the method are indicated by dashed outlines of the boxes.

The method begins at initiating 401 a resource request communication between a virtual machine and the hypervisor. Optionally, the initiation can be caused by an application running internally on any one of the two or more virtual machines requesting 400 additional resources. After checking, at a step 402, whether unallocated resources are available, if they are, these resources are allocated, at a step 403, to the requesting VM. If unallocated resources are not available, the method continues with broadcasting, at a step 404, a message to all remaining VMs asking to release unused allocated resources. The broadcasted message may also include a value for the requested resources. If there enough unused allocated resources can be released, at a step 405, the method includes dynamically releasing, at a step 406, resources from one or more VMs, and reallocating the dynamically released resources, at a step 403, to the requesting VM. This can be done, for example, by passing resource allocation instructions from the hypervisor to the requesting virtual machine. In case none of the VMs can release sufficient resources, a negative response message may be generated, at a step 407, and sent to the requesting VM.

Optionally, after the resource allocation or reallocation according to the method, the requesting VM may hot-plug these resources, at a step 408, for uninterrupted operation.

The guest VM operating system kernel may be modified in order to introduce a new driver to support this method. The driver exposes a user-space interface to the guest applications in VMs, via which the applications may request resource adjustment changes. Further, the driver is responsible for implementing a communication protocol between the guest kernel and the host kernel (the hypervisor), for communicating the request messages and handling the response messages. The hypervisor is responsible for receiving those messages from the guest VMs, and accordingly handling the requests by delegating the decision to a user-space software component running within the host, responsible for resource management and potentially implementing a variety of different resource management policies.

In the case of a guest VM requesting additional resources, the particular resource management component may identify that there are sufficient “free” unallocated resources on the host machine to fulfil the request adjustment immediately, and it may proceed in doing so by allocating those resources to the guest VM, which can be done by implementation-specific and architecture-specific steps. Alternatively, if no resources are available at the time of the request, the resource management component may proceed to dispatch a request release message to any (or all) of the other concurrently running guest VMs hosted in the same environment. If any (or several) of the guest VMs respond affirmatively and relinquish any resources, if the aggregate of relinquished resources are sufficient to fulfill the initial resource for resource adjustment, then the request may proceed.

Subsequently, a response can be sent to the requesting VM to confirm the success of the request, along with implementation-specific and architecture-specific information regarding the newly acquired resources. Following that, the guest VM operating system kernel driver receives the response, and according to the supplied information it can proceed to hot-plug the acquired resources. Finally, the user-space application that initiated the request is notified, so that the application can proceed with using the newly acquired resources. In the case where there are no available resources in the host to serve the request, and no other guest VM was willing to relinquish sufficient resources to fulfill the request, then a resource adjustment rejection message is returned to the requesting guest VM.

The non-program specific methods and systems described in the embodiments above are applicable to a plurality of VMs, Physical Servers, Cloud platforms, and Programs to cooperatively, dynamically and without downtime deficiency scale up and scale down the resources allocated to each VM in the system.

The functionality described herein can be performed, at least in part, by one or more computer program product components such as software components. According to an embodiment, the system 100 includes a processor configured by program code to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. A system comprising:
a processor;
a memory;
resources comprising at least one of processing resources or memory resources; and
a computer program stored in the memory, the computer program comprising two or more virtual machines and a hypervisor having access to the resources,
wherein the computer program is configured such that, in response to the processor executing the computer program:
at least part of the resources is allocated among the virtual machines;
any one of the virtual machines is configured to request additional resources by sending a resource request to the hypervisor;
the hypervisor is configured to receive the resource request from the requesting virtual machine and check for available unallocated resources;
the hypervisor is configured to allocate at least part of the unallocated resources to the requesting virtual machine, in response to unallocated resources being available; and
the hypervisor is configured to check for allocated resources that are releasable by any of the virtual machines that are not the requesting virtual machine, and reallocate the releasable allocated resources to the requesting virtual machine, in response to unallocated resources being unavailable.

2. The system of claim 1, wherein the computer program is configured such that, in response to the computer program being executed by the processor:
the hypervisor is configured to check for allocated resources that are releasable by any of the virtual machines that are not the requesting virtual machine by sending a request for releasing resources to the virtual machines;
the virtual machines are configured to receive the request for releasing resources, check for unused resources allocated to them, and send replies with information about the unused resources to the hypervisor; and
the hypervisor is configured to dynamically release the unused resources based on the replies received from the virtual machines, and reallocate the dynamically released resources to the requesting virtual machine.

3. The system of claim 2,
wherein the hypervisor is configured to reallocate the dynamically released resources to the requesting virtual machine by sending a resource allocation message to the requesting virtual machine, and
wherein the requesting virtual machine is configured to receive the resource allocation message from the hypervisor, and hot-plug the dynamically released resources in accordance with the resource allocation message.

4. The system of claim 1, wherein the processing resources comprise at least one of central processing unit cores or virtual central processing unit cores.

5. The system of claim 1, wherein the memory resources comprise random access memory.

6. The system of claim 1, wherein the memory resources comprise non-volatile memory.

7. The system of claim 2, wherein the hypervisor is configured to assign a value to the dynamically released resources, and reallocate the dynamically released resources based on their value.

8. The system of claim 1, wherein the hypervisor comprises a resource manager, and a communicator configured to send messages to, and receive messages from, the resource manager and the virtual machines.

9. The system of claim 2, wherein each virtual machine of the virtual machines comprises a communicator and a dynamic resource communicator library configured to:
receive resource requests from applications running internally on the virtual machine;
pass the resource requests to the hypervisor via the communicator;
receive requests for releasing resources from the hypervisor via the communicator;
process the requests for releasing resources; and
send replies with information about the unused resources to the hypervisor via the communicator.

10. A method for resource allocation in a system, the system comprising two or more virtual machines and a hypervisor, the method comprising:
initiating a resource request communication between a requesting one of the virtual machines and the hypervisor;
checking for unallocated resources available to the hypervisor,
in response to unallocated resources being available, allocating at least part of the unallocated resources to the requesting virtual machine, and
in response to unallocated resources being unavailable, checking for allocated resources that are releasable by any of the virtual machines that are not the requesting virtual machine, and reallocating the releasable allocated resources to the requesting virtual machine.

11. The method of claim 10, the method further comprising:
initiating a second communication for releasing resources between the hypervisor and the virtual machines that are not the requesting virtual machine;
checking for unused resources allocated to the virtual machines that are not the requesting virtual machine, and providing information about the unused resources to the hypervisor;
dynamically releasing the unused resources based on the provided information; and
reallocating the dynamically released resources to the requesting virtual machine.

12. The method of claim 11, the method further comprising:
reallocating the dynamically released resources to the requesting virtual machine by passing resource allocation instructions from the hypervisor to the requesting virtual machine; and
hot-plugging the dynamically released resources in accordance with the resource allocation instructions.

13. The method of claim 10, the method further comprising:
initiating a resource request from an application running internally on any one of the virtual machines prior to initiating the resource request communication between the requesting virtual machine and the hypervisor.

14. A computer program comprising program code configured to perform the method according to claim 10 upon the computer program being executed on a computer of the system.
